(19) United States
(12) Patent Application Publication
(10) Pub. No.: US 2010/0114780 A1
(43) Pub. Date: May 6, 2010

(54) WORKFLOW ASSURANCE AND AUTHENTICATION SYSTEM

(75) Inventors: Raglan Tribe, Hampshire (GB); Ken MacLauchlan, Hampshire (GB); Paul Freeman, Hampshire (GB); Colin Frey, Hampshire (GB); Stephen McSpadden, East Kilbride (GB); Mark Winter, East Kilbride (GB); Peter Winnington-Ingram, Livingston (GB)

Correspondence Address: MOORE & VAN ALLEN PLLC, P.O. BOX 13706, Research Triangle Park, NC, 27709, US

(73) Assignee: ITI SCOTLAND LTD., Glasgow (GB)

(21) Appl. No.: 12/375,201

(22) PCT Filed: Aug. 3, 2007
(86) PCT No.: PCT/GB07/02967

§ 371 Date: Mar. 4, 2009

(30) Foreign Application Priority Data
Aug. 3, 2006 (GB) 0615428.0

(51) Int. Cl. G06Q 10/00; H04L 9/00; G06K 7/00

(52) U.S. Cl. 705/50; 705/7; 235/375

(57) ABSTRACT

A method for authenticating a workflow that has one or more designated steps that require authentication of associated resources, the method comprising: using a reader instrument to read at least one security feature uniquely associated resources involved in the workflow; authenticating the security feature, thereby to authenticate its associated resource, and recording authentication information for each designated workflow step.

The present invention relates to a system and method for high integrity authentication and assurance of workflows.

### BACKGROUND OF THE INVENTION

Goods are often branded, with brand owners investing heavily in associating brands with certain favourable properties such as quality, safety and good design. Branding can impart significantly increased value to goods. Marks may also be used to act as a guarantee of safety or may even act as a certification mark, guarantee or indication of conformity to regulations. The quality and safety of goods and services may rely on a multitude of factors such as the specification and authenticity of component parts, the following of procedures, the use of the correct equipment and operations being carried out by operators having the correct training. In order to ensure quality and safety, brand owners and regulators need to keep control over these factors.

Controlling all aspects of a manufacturing process or supply chain can be difficult, because instructions given by brand owners or regulators can be mistakenly omitted, carried out incorrectly, circumvented or modified by, for example, shortcuts being taken, processing steps omitted or carried out incorrectly, incorrect parts or equipment used, untrained staff used or records being mistakenly filled in. In addition, mistakes or non-conformities can be covered up by retrospectively amending records. Further, if workflows are changed, it is possible that the new workflow is not substituted in place of the old workflow in every instance. These occurrences limit the certainty that a brand owner or regulator has in ensuring that the specified parameters have been met.

### SUMMARY OF THE INVENTION

According to one aspect of the invention, there is provided a method for authenticating a workflow that has one or more designated steps and involves a plurality of resources, the method comprising: reading a security feature uniquely associated with each resource involved in the workflow; authenticating each security feature, thereby to authenticate its associated resource, and recording authentication information for each designated workflow step. Preferably, the security feature is covert. By using security features to securely authenticate workflow steps, there is provided an assurance that the workflow has been complied with.

The resource may be a user and/or a location and/or an item and/or an apparatus. One or more of the resources may be associated with multiple security features.

The method may further comprise issuing a certificate certifying that at least one workflow requirement has been met. The certificate may be a seal. The certificate may contain covert security features. The covert security features may include cryptographic features. The cryptographic security features may include providing one key of a key encryption in the security features and another key in the workflow. The certificate may be a digital certificate. The certificate may be issued as an electronic and/or physical certificate.

The certification may be used as a requirement to be obtained before allowing a further workflow to be started. The certification may be a regulators certificate.

According to another aspect of the invention, there is provided a system for authenticating a workflow that has one or more designated steps and involves a plurality of resources, the system comprising: means for reading a security feature uniquely associated with each resource involved in the workflow; means for authenticating each security feature, thereby to authenticate its associated resource, and means for recording authentication information for each designated workflow step. Preferably, the security features are covert.

The system may include a central workflow authentication store for storing all recorded authentication information for the workflow.

The system may be operable to register new resources for use within the workflow system. The system may include means for applying one or more security features to a tag or marker associated with the resource being registered for use in the workflow authentication.

The system may further include means for producing or marking a certificate to indicate that one or more designated workflow steps are completed. The means for producing or marking a certificate may be arranged to apply covert security features. The certificate may be a digital certificate. The certificate may be issued as an electronic and/or physical certificate.

The system may be adapted to require provision of a certificate from a previous workflow before starting a new workflow. The certification issued and/or required may be a regulators certificate.

According to yet another aspect of the invention, there is provided a workflow authentication system configured to provide one or more workflows to a plurality of workflow stations, each workflow having one or more designated steps requiring authentication; receive authentication information that has been captured from at least one resource specified in the workflow from at least one of the plurality of workflow stations and record authentication information for each designated workflow step.

The workflows provided to the workflow stations may be sub-sets of another larger workflow. Additionally or alternatively different workflows may be provided to each workflow station.

The authentication information provided by a workflow station for a designated step may be sufficient to fully authenticate that step. Alternatively, the authentication information provided by a workflow station may be used together with other information to identify whether the workflow is authenticated. The other information may be provided remotely from the workflow station, so that authentication is finalised remotely from the workflow station. Using information from both the workflow station and the remote station improves security.

### BRIEF DESCRIPTION OF THE DRAWINGS

Various aspects of the invention will now be described by way of example only and with reference to the accompanying drawings of which:

FIG. 1 is schematic diagram of a system for providing workflow assurance;

FIG. 2 shows a plurality of resource tags for use in the system of FIG. 1;

FIG. 3 is a schematic diagram of the basic features of a workflow;

FIG. 4 is an illustration of how a master workflow may involve sub-workflows at a plurality of different locations and associated with different instruments;

FIG. 5 is a flow diagram of a workflow for fitting a spare part to an aircraft;

FIG. 6 is a block diagram of another system for assuring workflow, and

FIG. 7 is a schematic diagram illustrating that a complete workflow can only be assured when sub-workflow is authenticated and assured by each party involved

### SPECIFIC DESCRIPTION OF THE DRAWINGS

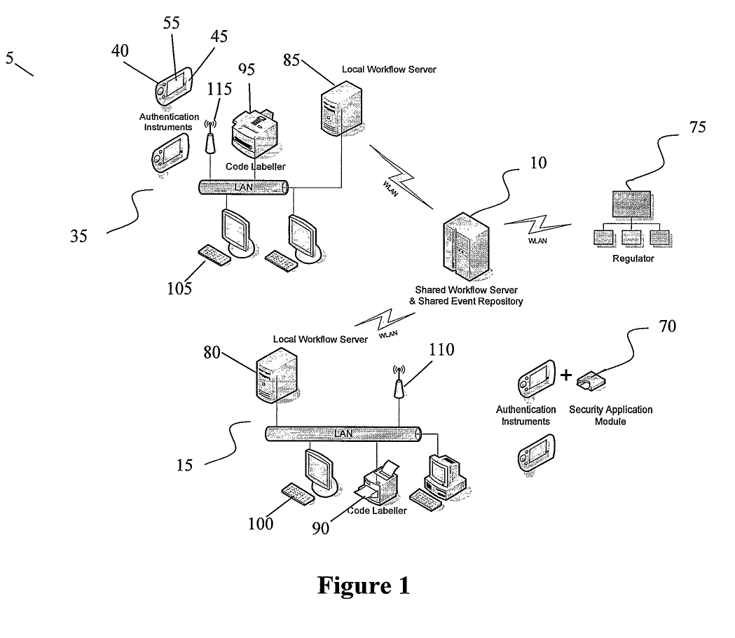

FIG. 1 shows a trust management system 5 having a shared workflow server 10 that is operable to communicate with at least one point of registration (PoR) 15 and at least one point of authentication (PoA) 35. The workflow server 10 is configured to provide one or more workflows to the PoAs 35, each workflow having one or more designated steps requiring authentication. It is also adapted to receive authentication information that has been captured by the PoAs from at least one resource specified in the workflow and record authentication information for those designated steps, thereby to build a complete authentication record for all steps in the workflow.

The workflows provided to the PoAs 35 may be sub-sets of another larger workflow. In this case, the sub-workflows could be distributed to PoAs in different locations, but all authentication data would be sent to the workflow server 10 and authentication of the overall workflow would be done centrally. Where sub-workflows are used, the whole workflow can only be authenticated in the event that all of the sub-flows are authenticated. Where multiple PoAs are used, the same workflow or sub-workflow may be provided to each. Alternatively, some of the PoAs 35 may be allocated different workflows from the others.

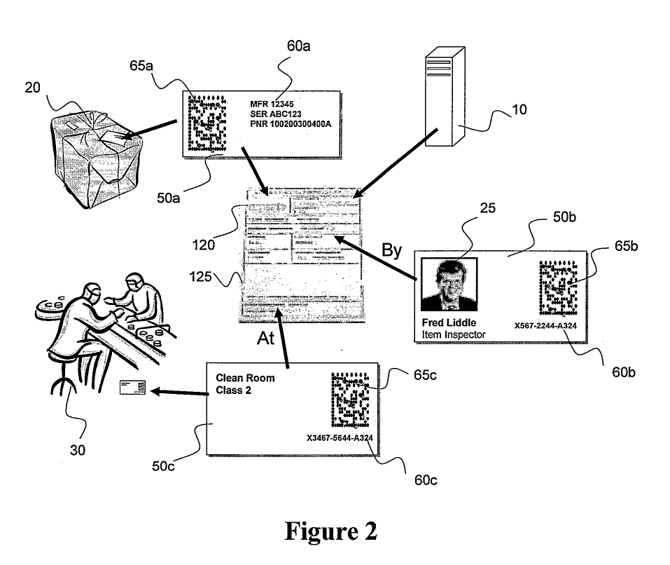

The PoRs 15 and PoAs 35 are adapted to receive and transmit data from/to data authentication devices 40. In use, the PoRs 15 are operable to register resources 20, 25, 30 that are to be involved in a specified workflow, as shown in FIG. 2. In particular, the PoR devices are capable of generating tags or identifiers for applying to new, that is not previously authenticated resources at a start or “registration” point. The PoAs 15 are operable to authenticate resources 20, 25, 30 as and when the workflow is being executed. Possible resources include items 20, users 25, locations 30, and equipment or anything that impacts or is specified by a workflow.

FIG. 2 shows various tags 50a-c that are used in the registration and authentication processes at the PoRs 15 and PoAs 35 respectively. Each tag 50a-c includes a data mark, for example a 2D matrix, which uniquely identifies the resource 20, 25, 30 with which it is associated. Embedded within each data mark is at least one covert security feature 65a-c, which may be implemented using any suitable technology for example as described in our co-pending patent application PCT/GB2007/002496, the contents of which are incorporated herein by reference. The covert security features 65a-c provide a means for authenticating the resources 20, 25, 30. Typically, the security feature 65a can be checked against records stored on the system or other security features (not shown) to ensure that they match an expected feature for that resource 20, 25, 30 in order to authenticate that resource 20, 25, 30.

The covert security features 65a-c may includes features such as markings in UV fluorescent ink, or small differences in register in the barcode. Any suitable covert security feature(s) can be used. These could be separately applied or integrated with the overt data carrier. Examples of separately applied covert features include patterns applied with UV sensitive fluorescent inks that are invisible when not illuminated with UV light and/or random fluorescent components that are included in a carrier substrate. Examples of security features that can be integrated into the overt identifier include fluorescent compounds that are included in the ink used to print the overt carrier, which may be simply detected and/or its spectral properties analysed. Multiple features may be used. These may take the form of different layers of fluorescent inks and/or different inks in specified areas of the barcode, with each area being assigned to be a different security feature.

Preferably, at least one of the tag security features 65a-c is readable to provide one key of a public/private key encryption code, such that it can be used with a corresponding key supplied by the workflow, thereby to provide secure authentication. Several covert tag security features 65a-c may be associated with each resource identifier, each one containing a different encryption key. This enables switching between keys by selecting the tag security feature 65a-c used, should any one of the covert security features 65a-c become compromised. The tag 50a-c may include a digital or virtual certificate containing a code corresponding to one key of a public/private key encryption code.

Each tag 50a-c can be read by the authentication devices 40. The authentication devices 40 each include apparatus 45 for reading information on the tags 50a-c, a display for relaying instructions to a user 55, a memory for storing workflow and authentication event data and a communications link for allowing communication with at least one of the PoAs 35 or PoRs 15. The authentication devices 40 are adapted to collect authentication event information from the tags 50a-c, such as the identity of the resources 20, 25, 30 involved in the workflow steps and authentication information from the tag security features 65a-c. The apparatus 45 for reading the tags 50a-c will vary depending on the tags 50a-c used with the system 5. Examples of possible reading apparatus 45 include barcode readers, UV light sources/detection apparatus, radio frequency identification (RFID) tag readers and CCD detectors.

The authentication event information that has to be captured is defined within workflows that are downloaded from the shared workflow server 10 via the PoAs 35 and stored within the authentication devices 40. The authentication devices 40 are provided with security application modules (SAMs) or some other tamper proof security component 70 to protect the workflows from reverse engineering or tampering. Using a SAM or like component 70 provides a number of significant technical advantages. For example, it enables tamper proof communications between the instruments and the server. It also allows within instruments secure local, off-line validation of security features containing, for example, an encrypted check such as a MAC and secure processing of certain elements of a tag, for example location of a pertinent security feature within a barcode. The instrument based SAM also allows secure recording of event records and stamping of records with time, location, workstation etc and secure execution of a workflow, for example to ensure that all required steps have been complied with.

The shared workflow server 10 acts as a centralised shared workflow store and shared authentication event repository and is operable to communicate with all PoAs 35 and PoRs 15 to provide the most up to date workflows and receive authentication event information. The authentication information captured from the security tags may be sufficient to fully authenticate the associated workflow step at the instrument 40, so that the authentication event information sent to the server 10 is indicative that the step has been authenticated. Alternatively, the information captured from the tags may be used together with information at the workflow server 10 to determine whether the relevant workflow step is authenticated. In the event that it is, this information is stored at the server and/or the PoA. If not, a message may be sent to the PoA 35 to indicate that the step was not authenticated, so that the workflow cannot be completed.

Communications between the PoAs, PoRs and the server 10 are provided over a wide area network such as the internet. In this way, full traceability is captured and managed in such a way that all items and events can be traced through all workflows back to the source. In addition, if any irregularities in workflows are found then other affected items can be traced forward to their destinations. Authorised users such as regulators 75 may access the shared workflow server 10 in order to verify that all the workflows have been carried out in the specified manner.

The PoRs 15 and PoAs 35 each include a local workflow server 80, 85, at least one code labeller 90, 95, at least one data input/output device 100, 105, for example a PC, and at least one communications apparatus 110, 115. These are all connected via a local area network (LAN). The local workflow servers 80, 85 are arranged to receive workflows and other data from, and send authentication data to, the shared workflow server 10 over a network connection such as a wireless local area network (WLAN) or the internet. Communications between the local workflow servers 80, 85 and the shared workflow server 10 are encrypted to provide maximum security, e.g. by using secure socket layer (SSL) encryption. The local workflow servers 80, 85 have databases for storing workflows for provision to authentication devices and for storing authentication events for transmission to the shared workflow server 10.

The code labellers 90 of the PoR 15 are operable to create the tags 50a-c to identify the workflow resources 20, 25, 30. The code labellers 95 of the PoA 35 are operable to create certification marks 120 or to produce certificates 125 containing such certification marks 120 certifying that a workflow or a designated part of a workflow has been completed and authenticated. Every certification mark 120 created is stored at the shared workflow server 10. Data for use by the code labellers 90, 95 can be input using the input/output devices 100, 105. These are operable to allow input of requests to the system 5 and data relevant to a resource 20, 25, 30 or any other input required by the workflow. The data input/output devices 100, 105 may be further operable to display requests and instructions, including instructions on how to carry out workflow steps, from the system to users.

All resources 20, 25, 30 in the system have to be registered at a PoR 15. This has to be done by a registered or authorised user having an ID card that has a resource tag 50b. The user's resource tag 50b is only provided once a sub-workflow to determine that a user meets appropriate requirements has been completed. When new resources are being registered, the authentication device 40 of the PoR reads the resource tag 50b of the user entering the required data. This involves reading information from covert security features 65b in order to identify and authenticate the user. Once this is done, data is entered relating to the new resource 20, 25, 30. For items 20, the data would typically include information such as the item type, specification, part number and date of manufacture. For equipment, the data would typically include equipment specifications and operating parameters. For users 25, the user's training and experience may be used. For locations 30, the room temperature and humidity may be entered.

In any case, once the resource data is entered, then a registration event record is generated and is sent from the PoR 15 to the shared workflow server 10. The registration event record contains the ID of the user entering the new resource, authentication details, the details of the workflow used and the resource 20, 25, 30 being registered. In this way, the resource record is tied to the user who inputted the data. By checking other parameters against the workflow, the registration procedure is validated, for example that the PoR 15 is designated for registration of a particular item 20 and that the authentication device 40 is valid. If all the registration parameters are in accordance with those specified in the workflow, an affixable tag 50a-c may be produced which identifies the resource 20, 25, 30.

If an item 20 has already completed a previous workflow, registration may be achieved by simply reading the certification mark 120 produced during the previous workflow and accessing the associated data, which is stored at the shared workflow server 10 or on the item itself. This associated data might be any parameters that were captured from the previous workflow, such as: date and time stamp, expiry date, tolerance parameters or actual workflow operating conditions.

The workflows contain a series of workflow instructions detailing how to carry out steps in an activity or process, a specification of the items 20 upon which the workflow is usable and the other resources that are to be used for each step. The workflow also contains the instructions and requirements for authenticating each resource 20, 25, 30. Examples of instructions for authenticating resources include instructions for the authentication device 40 to scan a tag 50a-c in a particular area or use a particular tag reading apparatus 45 or provide a key to use with a key extracted from a resource or item security feature 65a-c to provide an authentication code. Operator instructions may be generated at the PoA 35 to tell the operator what to do with the item that has just been scanned. For instance, a goods inwards workflow could tell the operator whether to put the item into storage, put the item into a bay for immediate dispatch or tell the operator not to accept the goods at all due to irregularities detected by the authentication.

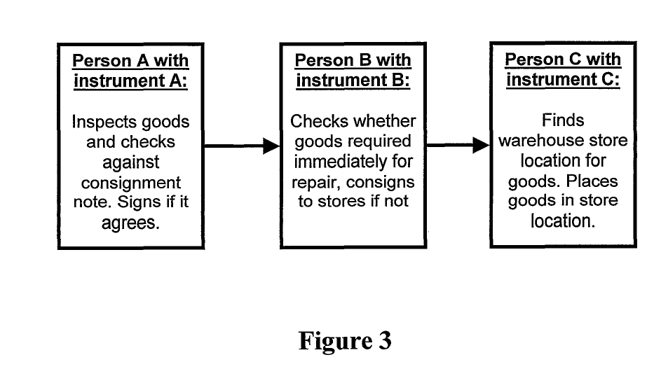

Essentially, a workflow can be broken down into different actions that pertain to different human operators in the overall workflow, as shown in FIG. 3. Each operator instrument supervises their actions through a sequence of screens that give the appropriate instructions to the operator, collects any appropriate workflow input parameters or requirements through screen forms and performs any authentication scans of the relevant resources relevant to the workflow. If all steps in the workflow have been correctly authenticated then the last step can create a security mark that goes onto the item or packaging, which then proves the workflow compliance to any subsequent recipients of the item.

Examples of workflow requirements that have to be authenticated include the following: verification that a property of an item 20 has been input by an appropriately qualified operator and/or that an operator has received certain training and that this has been verified by a supervisor with appropriate authorisation and/or that a location is maintained within a certain humidity range, dust level and temperature range and that this has been certified by an authorised person and/or electronically monitored.

The workflow may be requested by a user or automatically selected on the basis of the information input, e.g. item type. If the correct workflow is not already stored on the appropriate local workflow server 80, 85 or authentication device 40, the shared workflow server 10 retrieves the appropriate workflow and returns it to the requesting PoR 15 and any relevant PoAs 35. The workflow instructions may be viewable on the authentication devices 40 or on the displays 100, 105 associated with the PoAs 35 and PoRs 15. Instructions may also be provided directly to suitably programmable equipment such as robotic transporters and processing equipment.

Workflows can be adapted, updated and remotely modified, to allow, for example, for the use of authentication devices 40 in a number of workflow areas or when a workflow requires updating to coincide with a part upgrade or recall. Typically this would be done centrally at the workflow server 10. A designed workflow only becomes official once the appropriate authority has digitally signed it. Only digitally signed workflows can be deployed to the instruments to prevent unofficial tampering with the workflow.

To allow a digitally signed workflow to be accessed, each instrument 40 includes or has access to a key, typically the public key or a public/private key pair, that can decrypt the signed workflow. A configuration management system within the server 10 ensures that all instruments 40 are uploaded with the latest workflows each time the instruments are synchronised with the workflow management system. Even if a rogue workflow was deployed on an instrument it could not be executed because it would lack the correct digital signature, in other words the instrument could not decrypt it with the appropriate public key. Again, this would generate bad authentication events and prompt subsequent investigations.

As an item 20 moves through the workflow, the resources 25, 30 used are recorded using the workflow authentication system via secure authentication of the tags 50a-c associated with the item 20 and resources 25, 30 using the authentication devices 40 to generate authentication data. The authentication data is primarily collected by reading the tags 50a-c associated with each required item 20 or resource 25, 30, particularly reading tag security features 65a-c. Several items 20 and resources 25, 30 may require to be authenticated for each workflow or workflow step including the item 20 being processed, the users carrying out the procedure(s) 25 and the location 30 and equipment being used for the processing. As noted before, authentication can be done locally or off-line at the instrument or remotely or on-line at the server 10. In either case, ultimately the authentication data confirming successful authentication or otherwise is stored at the server 10, thereby providing a complete and secure audit trail for all key steps of the workflow.

The manner of collecting the required data can vary depending on the item 20 or resource 25, 30. Alternatively, this may be specified in the workflow. Examples of controlling the collection authentication data include providing instructions to the user via the display 55 of the authentication device 40, for example, to scan in a certain part of a tag 50a-c. Alternately or additionally, the authentication device 40 may be instructed to read the machine readable tags 50 in a different way, for example a bar code scanner may be activated for reading a bar code rather than an ultraviolet light scanner for reading fluorescing ultraviolet marks. A further example of effecting a change in required data may involve a change in the data analysed or the way it is analysed, for example changes in register between the bars in a bar code may be used rather than a code extracted from the bar code in the conventional fashion using the width and spacing of bars.

The scanned data is compared to the requirements of the workflow. This may involve accessing secondary data from a database, for example, if a room ID code is provided by the tag, then the conditions which have been certified for that room resource may be accessed from a database using the tag data and used to compare with the workflow requirements to ascertain if the room is valid to allow authentication. Authentication event data is passed from the authentication devices 40 back to the shared workflow server 10 via the PoAs 35.

Authentication event data for each workflow is stored on the shared workflow server 10. In this way, the workflow steps are tied to the resources 25, 30 used. This allows traceability of the resources 25, 30 used and also an assurance that correctly specified resources were used for each workflow or workflow step. The use of resource tags 50b-c in this way ensures that the resource 25, 30 recorded was actually used, as access to the resource tags 50b-c is required for recording the event. The presence of security features 65b-c, the selectability of security features 65b-c and the use of encryption make it difficult to produce a counterfeit or generic resource tag 50b-c. All authentication events are time stamped and stored on local 85 and/or shared 10 workflow servers and so records cannot be retrospectively altered, even with the original tags 50b-c.

Upon completion of the entire workflow or of specified key steps defined in the workflow, certificates 125 may be produced to indicate completion of the workflow or key step. The certificate 125 may be physical, such as a certification mark 120 applied to paper using the code labeller 95 at a PoA 35, and/or virtual, e.g. an electronic certificate. The certificate 125 includes appropriate security features 120 which may be similar in form to the tag security features described above 65a-c. This is advantageous in that the authentication trail is in the form of certificates 125 verifying each workflow or key step that has been completed. This further prevents retrospective alterations of the workflow record, as each user at each stage in the workflow only has access to their own part of the workflow, with previous workflow stages being represented only as a certificate 125. A further advantage is in traceability, as the presence of the required certificates 125 is quickly and easily checked. The resources 25, 30 associated with each step can be verified at the shared workflow server 10. Any deficiencies in the workflow can be assigned to a particular resource 25, 30 and actions taken accordingly, for example recalling all items 20 that have come into contact with a certain resource 25, 30 or workflow, or centrally altering the tag security feature 65a-c used.

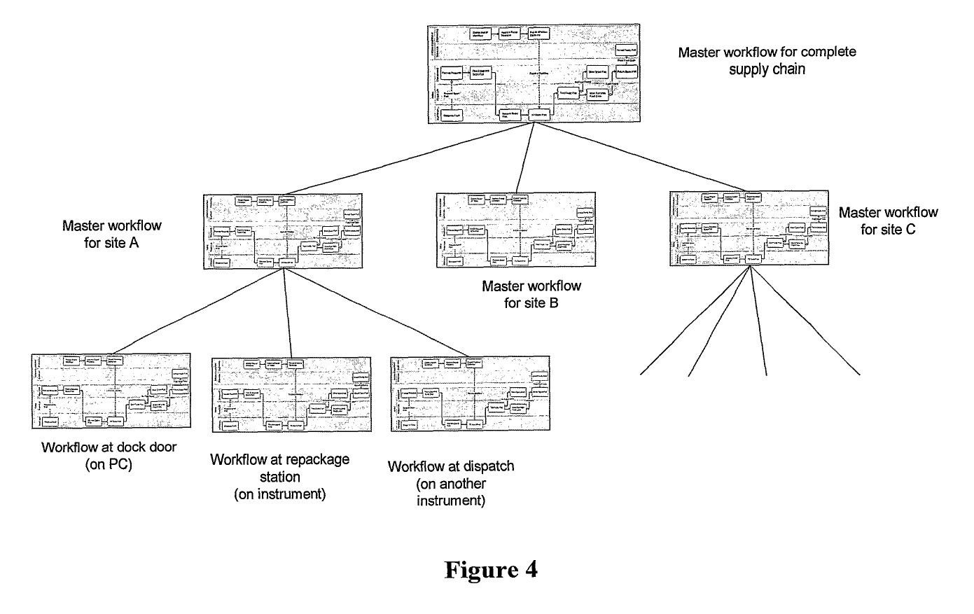

The system and method described herein are advantageously capable of ensuring workflow compliance at many levels. A particular example of this is a workflow to process an item 20, which relies on further sub-workflows to authenticate that the appropriate resources are involved in the main workflow. As shown in FIG. 4, each of the sub-workflows may be associated with different physical locations and different instruments. For example, the sub-workflows required to authenticate users may include workflows to ensure that users are trained in certain procedures or have appropriate experience. Further sub-workflows may be required to ensure that locations meet certain standards, for example in regards to temperature, humidity, cleanliness, security or facilities. Equipment can be verified to be of the correct type, with an up to date service history and operating within specified parameters. The sub-workflows may themselves rely on further sub-workflows, for example the fact that a user has received the correct training may require to be validated by an approved supervisor. For that supervisor to achieve approved status may require completion of an approved person sub-workflow.

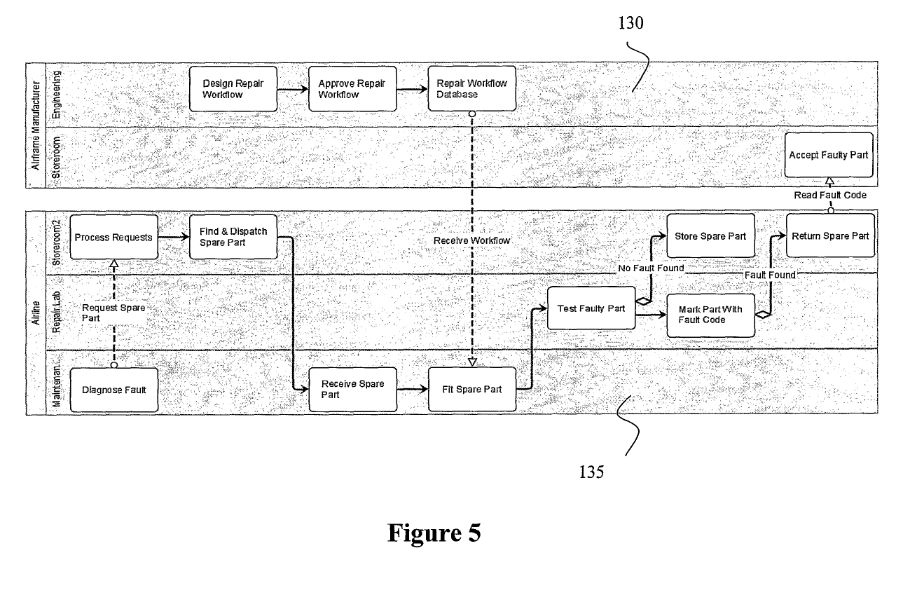

FIG. 5 shows an example of a workflow that could be assured using the system and method of the present invention. This shows a workflow procedure for fitting a spare part to an aircraft. There are two key parts to the workflow—the steps carried out by the aircraft manufacturer 130 and the steps carried out by the airline 135. The airline's repair department is equipped with a PoA 35 and authentication device 40. The workflow assurance system is configured to guide the engineer through the spare parts fitting procedure by downloading the appropriately assured workflow from the manufacturer's shared workflow server 10 into the airline authentication device 40 via the airline's PoA 35. The instructions can be displayed on a terminal 100 or printed out but are preferably shown on a screen 55 on the authentication device 40. The airline 130, personnel, equipment and facilities are assigned machine-readable tags 50b-c either directly by the airframe manufacturer or airline, or after being certified by completion of a certification workflow.

When key steps have been completed and authenticated, the authorised user who is enrolled to the instrument signs off their key step by pressing, for example, pressing a button on the instrument screen, entry of a PIN code or scanning of their security ID tag 50b. This can be done at designated points within the workflow or merely at the end. Once this is done, an authentication event message is generated and eventually stored in the database at the shared workflow server 10. Depending on the agreed business policies, this database could be accessible by the item manufacturer, the regulator or the workflow owner to support any subsequent investigations. The workflow assurance system can apply certification marks 120 to paper certificates 125 and the items 20 to prove the correct completion of key stages of the workflow as a result of the proper authentication event. Additionally, digital signatures and certificates may be generated.

As well as ensuring that parts are fitted in accordance with specified workflows, the system 5 in which the invention is embodied can be used to identify whether a part that is suspected of being faulty part is really faulty. To do this, a manufacturer defines a faulty part test workflow setting out key steps that have to be authenticated securely. By completing the faulty part test workflow prior to returning the part to the manufacturer, unnecessary returns can be avoided. Using the faulty part workflow and feeding the results back into the manufacturer's shared workflow server provides the manufacturer with an early indication of any fault in the part that may require further action, for example a recall. The traceability afforded by the secure association of resources also allows quick tracing of all parts that may be similarly affected, for instance, this would enable the regulator to identify all other aircraft that may be affected by the faulty workflow so that they may be grounded.

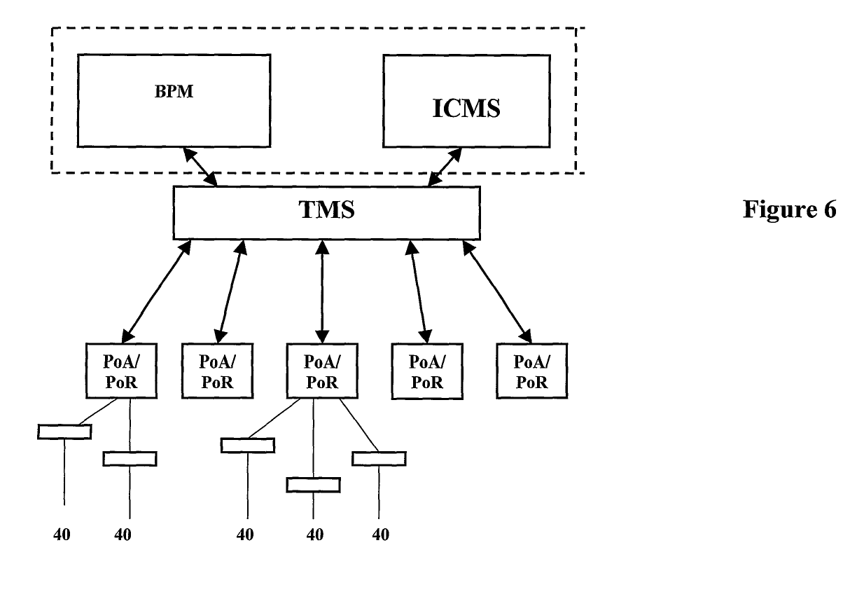

FIG. 6 shows another implementation of a system that can be used for workflow assurance in accordance with the present invention. This is described in more detail in PCT/GB2007/001248, the contents of which are incorporated herein by reference. This has a brand protection server (BPS) that can communicate with PoRs and PoAs provided at various locations in a product distribution chain. The reader devices are operable to read brand protection features/tags/unique identifiers, for example, barcodes, one-dimensional or two-dimensional, RFID tags, fluorescent tags, or any other suitable taggant types for identifying a resource. The reader devices are also adapted to read one or more secure features for authenticating that resource identifier taggant. The reader devices may include user authentication devices such as, for example, smart card readers, for reading user identification information provided by a user for authentication purposes. In some cases the reader devices may also have a write capability so that they can generate taggants including security features in labels, as well as read them. In a typical supply chain, a very large number of PoAs and PoRs are likely to be associated with the BPMS, possibly spread over a number of different countries.

The PoRs and PoAs communicate with the brand protection management server system using whatever standard communication method is most appropriate for them, e.g. TCP/IP over LAN for fixed devices, or WiFi for portable devices or GSM etc. One or more reader/writer devices may be linked/served using local networking such as WiFi or Ethernet, to a single PoR control device, e.g. a client Personal Computer (PC). Similarly several authentication devices 40 may be linked/served in a similar manner by a main PoA, e.g. a client personal computer (PC).

Included at the brand protection server is a trust management system (TMS) for ensuring security across the entire platform and a brand protection management system (BPMS) for analysing and storing brand management data, and controlling brand related features or functions. Also provided at the server is an instrument configuration management system (ICMS) for storing known configurations, locations, users, and modalities of the PoRs and PoAs and their associated authentication devices 40. The ICMS is responsible for downloading to instruments workflows and/or policies that are defined in the BPMS, as well as configuration instructions. This ICMS manages these for control of each PoR and PoA instrument in the system.

The policies include control or configuration information specifying the workflow, as well as the type of security feature that is to be read, the type of processing that is to be used to authenticate a particular feature, the grade or role of user approved to use the reader, and any other security feature reader information. Included in the ICMS is a component of the trust management system, typically implemented on a Hardware Security Module (HSM) or some other tamper proof security component, such as a Secure Application Module (SAM). All data to the instruments in the field flows through the TMS, thereby to ensure secure transfer. To ensure local security, each PoR and PoA device includes its own trust management system component.

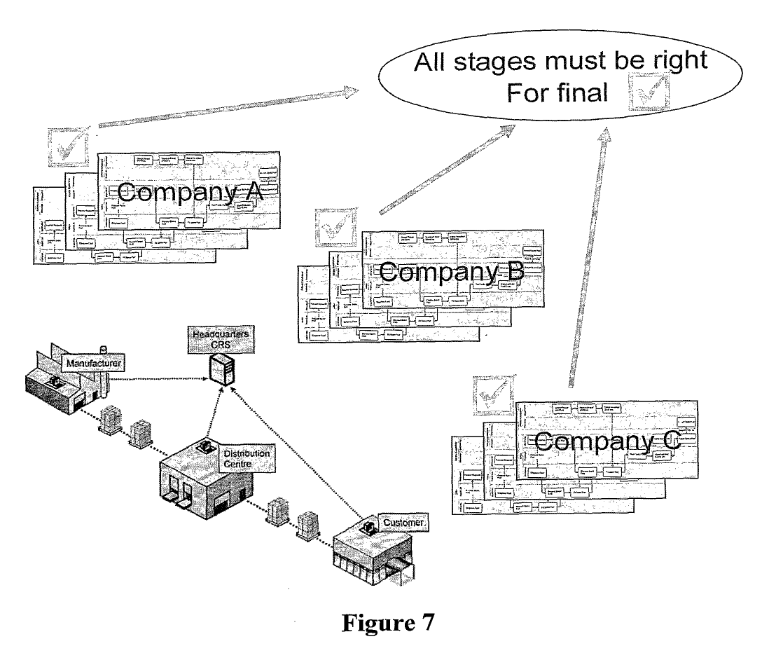

Each PoA/PoR reader instrument is loaded with workflows, as set by the ICMS. The workflows define the steps that the instrument is to authenticate and how to authenticate them. Each instrument workflow may be associated with a particular brand and may identify the organisation the workflow is associated with, and their hierarchy. Workflows may be associated with individual instruments or groups of instruments, for example instruments of a particular type, as shown in FIG. 7. Some may only be relevant with the context of a particular PoA system. These may identify which instrument activities can be loaded onto the instruments. Each activity must be associated with the appropriate item type and brand-owner identification (ID) for that workflow. Typically, there is a default mode when no brands/items are selected. The brand protection instrument activities define all the aspects to do with the read/scan, such as what algorithms should be used, what script can be used, etc. Since the steps taken to verify a code could be complex, these are controlled by the associated activity policy and may involve the display of instructions on the instrument to the user. For example, the instructions might involve first scanning part of the code, and a next step to retrieve further instructions from the PoA or the BPMS. These instructions may in turn lead to further steps requiring instrument interaction with other parts of the system.

The PoAs may be configured to authenticate resources locally or off-line, that is without reference to the BPMS. In this case, authentication events captured at the PoAs are processed in the instrument itself to determine whether they are authentic, and the result stored at the instrument and sent to the BPMS for later analysis to identify possible anomalies. Alternatively, data captured by the readers is sent to the BPMS for authentication, and so in this case, authentication is done on-line.

Once a workflow or policy is deployed to an instrument it is desirable to ensure that it cannot be altered maliciously. Preventing such tampering can be achieved by creating a security specification. This is stored separately from the main workflow and defines an essential sequence of secure operations within the workflow that have to be executed. As the workflow is being executed, any steps that require authentication are monitored and checked against the security specification to ensure that each essential step has been satisfactorily completed and in the correct, pre-defined order.

As an example consider a workflow for generating a new label or tag for applying to an item that already bears an identifier/security feature or brand protection feature. In this case, the new label can only be generated if the existing feature is read and authenticated. Hence, the essential steps of the security specification are: ReadBPF and GenerateBPF. Enforcing this sequence of essential steps prevents a counterfeiter from introducing into the distribution chain a number of items without an association to an existing package. In other words, the GenerateBPF step is only legal if the previous command was ReadBPF. Hence, in the event that the policy was maliciously hacked and the ReadBPF command removed, the security specification would highlight a violation of workflow sequence. Appropriate action is then taken, for example to disable the workflow and notify the BPMS or workflow server 10, or to another system. Optionally, a supervisor may be informed that there is a potential security violation to investigate.

The workflow assurance system of the present invention can be used in many different supply chain environments, for example a repackaging plant where items, such as boxes of pharmaceutical pills, are repackaged. The pharmaceuticals will on occasion be sourced from a foreign supply chain, and then be repackaged for the local market in a facility licensed for this purpose. In this case, it is important to preserve the pedigree of the pharmaceutical, so that, where it is serialised with a BPF, the lineage of the new label on the outgoing packaging can be traced to the incoming packaging, thus ensuring for the consumer or pharmacist that they can verify that the item is genuine. To this end, the workflow assurance system of the invention can be used to guide a pharmaceutical repackager through a regulated workflow and generate a cryptographic certification mark 120 on a tamper-evident label 125 for sealing the new packages. This security seal 125 proves that the drugs were unpacked from the original manufacturer's sealed packet, the packaging is in accordance with the regulators guidelines and the drugs were handled in the right conditions.

At the re-packager's premises, an operator and the operator workstation are authenticated. The operator scans the identifier and security feature on the incoming external package and the system authenticates that incoming pack as being valid and legitimate (i.e. giving a trusted point of reference), otherwise the repack supervisor is alerted and the pack is logged as invalid with an alert being possibly raised. The operator then opens the incoming authenticated external package. The operator may then remove the existing instructions and replace them with instructions suitable for the local language, usage and/or regulations. The existing outer packaging may be retained or may be replaced by new outer packaging. The brand protection feature, with its resource identifier and security feature, to be associated with the item's outgoing package is created, for example a label printed, in advance or during the repackaging process. A relationship is established and maintained between the old label and the new label so as to monitor, trace and alert on the pedigree of the item for stakeholders in the brand and supply chain.

To ensure the pedigree of the goods, the workflow assurance system gathers evidence at each stage of the workflow via the scanning and recording of tags 50a-c having security features and comparing tag 50a-c information with workflow requirements in order to establish the users, locations, original item marks and activities. The final seal 125 is only generated if all of the evidence is present and correct. The seal 125 may include a digital signature from the regulator that certifies accordance with the regulators approved workflow. The combined digital signature acts as a trust point for all downstream recipients of the drugs. In accordance with the invention, the workflow assurance system 5 ensures that there is no other way of generating this cryptographic certification mark without accurately following the workflow procedure, with all the key stages being verified by association with a resource 20, 25, 30 via the detecting of tag security features 65b-c. Hence, the complete workflow can only be signed off as being assured in the event that all sub-workflows are assured, as shown in FIG. 7 (where the “tick” indicates that the workflow is assured). In practice, it is envisaged that the authorisations from all steps would be easily accessible by the regulator 75 by a link to the shared workflow server 10, so that at any stage the regulator could check on the integrity of the workflow process.

Supplementary data relating to the item may be used to authenticate the pedigree. For example, it has been known for the expiry date on packages or items to be fraudulently modified. To limit the possibility of this happening, the incoming packages may be associated with MST compliant data including supplementary data, for example, the expiry date. The supplementary data is securely authenticated. When the operator scans the BPF on the incoming package, the pedigree of the supplementary data is authenticated by the MST system. This supplementary data is then embedded by the MST system in the new BPF associated with the item's outgoing package, again securely authenticated. By this method the pedigree of the supplementary data associated with the outgoing package is ensured within the trust management domain of the MST system.

In another extension of the invention, human readable supplementary data is verified against authenticated supplementary data. This extension can be applied to any MST System authentication scan irrespective of whether re-packaging is involved. In this case, an operator scans a BPF that does not include supplementary data. The BPF does however contain sufficient serialisation data, e.g. batch code or serial number, uniquely to index supplementary data, e.g. expiry date, held in an authenticated form within a database in the MST System. The MST System accesses the supplementary data using the serialisation data and presents the data to the operator, explicitly requesting the operator to confirm that this is the same as the supplementary data presented in human readable form on the package or item.

Where re-packaging is involved, supplementary data can be incorporated in a new security feature associated with the outgoing package where the incoming package did not incorporate this data. The use of linked authenticated inputs, process steps and outputs to authenticate outputs can be applied to maintain the pedigree of authentication through a complex of different steps. Complex supply chains involving re-packaging are known to create problems in maintaining the pedigree of items and the information associated with them. This invention and its extension provide means whereby stakeholders can maintain this pedigree with the associated value that this brings.

When applied to a supply chain, the system described above has the ability to track individual items as they move through the supply chain by collecting all the “events” associated with each. By flagging items as returned and tracking the outstanding items that have been flagged for return, there is provided a very simple mechanism for allowing the brand owner to understand the status of returned items. This could be done by generating and applying to the returned item a label or tag with some form of “return” identifier, preferably unique to the item, and then using this to track the return path. In addition, a specific returns workflow could be defined. This helps ensure that forged goods do not enter the returns pipeline, enforces the correct handling of items marked for return and allows accurate accounting for the value of returned items. These advantages mean that returns can be handled more accurately, at lower cost and with better understanding of the current situation and causes. As an enhancement, additional information on the reason for returning the item could be captured.

To achieve this the BPMS or workflow server would have to be able to recognise that an item has been flagged for return and when an item has been successfully returned. It should also be adapted to include a series of policies for handling returned items. Optionally, additional information on the reasons for return may be stored. The BMPS may also be adapted to supply data to PoAs on outstanding items flagged for return and include additional functionality in the analysis module to allow it to interpret the current returns situation. Ideally, it should also have an interface to an existing billing system or the MST system is extended to cover the financial transactions of the supply chain.

A skilled person will appreciate that variations of the disclosed arrangements are possible without departing from the invention. For example, the instruments may be configured to extract multiple virtual covert security features from a single physical feature. For example, the relative intensity of fluoresced light at two or more wavelengths could be determined, as could the ratio of the intensity of fluoresced light between first and second wavelengths and/or the ratio of intensity of fluoresced light between second and third wavelengths and so on. Also, multiple aspects of each physical security feature can be used to create multiple layered security features, for example, a first security feature could be the presence of a fluorescent pattern, a second security feature could be the shape of the pattern and a third security feature could be the wavelength ratios.

To increase security, the covert features may be entangled with other data on the tags 50a to c. This may involve physically entangling the security feature with the data mark or resource identifier, so that there is some degree of physical overlap. For example, the tag could be provided on a substrate that contains a hidden pattern only made visible by the use of the reader and/or provided on top of an RFID tag that is embedded in the substrate. Another option is to use data entanglement to provide a link between the security feature and the data carrier. By this it is meant that data in the data carrier is used in some way to generate one or more of the security features. For example, the pattern of deposition of each security feature may be related to the data in the data carrier. Alternatively, data may be encoded onto the covert security features. This data can be used with known encryption technologies to provide increased security. An example of this would be including data encrypted with a key on a covert security feature for use with a key encryption algorithm. The other key required to decode the encrypted data may be included on another covert security feature or a data carrier or assigned to a user or data carrier reading device or available at the server.

Requiring the use of two encryption keys for the authentication of the resource allows multiple users to have separable authentication with each user utilising a user specific key to obtain a user specific authentication code. This would make the resource tag hard for other users to copy, as each user only has access to the data afforded by their own user specific key. Multiple keys may be provided on associated multiple covert security features. Hence, if a key were compromised, a different security feature 15 may be selected. In addition, encryption may be used to provide selective access to data on the resource tag by disclosing certain security features to certain classes of user to allow them to obtain only the keys contained on the disclosed features.

Another method for increasing the data content and security of covert security features is the use of inter-related security features, whereby covert security features are applied in a manner or pattern based upon known relationships between them. This gives the opportunity to authenticate by using a first feature, a second, feature and a function of both features. This increases the number of security features available and also increases security since determining the function of two features requires both features and the relationship between them to be detected and decoded.

Using two features and a function of these, provides additional benefits to parties in a supply or process chain wishing to provide authentication to other parties but also retain their own specific security features. For example, if a substrate supplier sells a substrate to a converter who then sells the substrate on to a user, two covert security features may be incorporated into the substrate's data carrier. The first covert security feature may be assigned to be used by the converter, the second covert feature may be assigned to the user, but the combined covert features retained by the supplier. Thus, each party can have individual assurance that the data carrier is genuine. The converter only knows about the first security feature and can check this to ensure the substrate is genuine, the user can check the second security feature and the supplier can check the function of the two. This arrangement is useful, for example, in allowing each party in the chain to determine that a returned product was genuinely originally sourced from that party by checking their own covert security feature.

Although various data carriers for identifying resources have been described in examples above, such two dimensional data matrices, a person skilled in the art would realise that the above system may be used with a range of suitable data carriers, such as machine readable number codes or one dimensional bar codes. Similarly, although examples of security features have been given above, any suitable security feature known in the art may be used. In addition, whilst in the examples given above, the security features are preferably covert, overt features may also be used. Additional authentication checks may also be carried out on the data. This could be done by comparing at least part of any security data captured with data from an approved list. The data compared may be an entire data value. Accordingly the above description of the specific embodiment is made by way of example only and not for the purposes of limitation. It will be clear to the skilled person that minor modifications may be made without significant changes to the operation described.

1. A method for authenticating a workflow that has one or more designated steps that require authentication of associated resources, the method comprising:
using a reader instrument to read at least one security feature uniquely associated resources involved in the workflow;
authenticating the security feature, thereby to authenticate its associated resource, and
recording authentication information for each designated workflow step.

2. A method as claimed in claim 1 comprising identifying the resource using a resource identifier.

3. A method as claimed in claim 2 wherein the security feature is included within the resource identifier.

4. A method as claimed in claim 2 wherein the resource identifier is unique to the resource with which it is associated.

5. A method as claimed in claim 2 wherein the resource identifier comprises at least one of a bar code; an RFID tag; a light sensitive tag; a fluorescent tag; or a unique number.

6. A method as claimed in claim 2 wherein the reader instrument is operable to read both the security feature and the resource identifier.

7. A method as claimed in claim 1 wherein the resource includes at least one of a user, a location, an item or an apparatus.

8. A method as claimed in claim 1 wherein the security feature includes an encryption key for use in the step of authenticating.

9. A method as claimed in claim 8 wherein the encryption key is one key of a public/private pair.

10. A method as claimed in claim 1 comprising authenticating the security feature using cryptographic coupling with one or more other security features.

11. A method as claimed in claim 2 comprising authenticating the security feature using cryptographic coupling with the resource identifier.

12. A method as claimed in claim 1 wherein the security feature is covert.

13. A method as claimed in claim 1 wherein the security feature is overt.

14. A method as claimed in claim 1 wherein two or more security features are provided for each resource.

15. A method as claimed in claim 1 wherein at least one security feature is provided on or at the resource and/or at least one security feature is provided remotely, for example at a remote server.

16. A method as claimed in claim 1 comprising issuing a certificate certifying that at least one workflow requirement has been met.

17. A method as claimed in claim 16 wherein the certificate is electronic and/or physical.

18. A method as claimed in claim 1 comprising allowing authentication of at least one of the designated steps only on completion of one or more preceding authentication steps.

19. A method as claimed in claim 1 comprising authenticating the security feature at the reader instrument.

20. A method as claimed in claim 1 comprising sending data captured by the reader instrument from the security feature to a remote location for authentication.

21. A system for authenticating a workflow that has one or more designated steps involving a plurality of resources, the system comprising:
means for reading a security feature uniquely associated with each resource involved in the workflow,
means for authenticating each security feature, thereby to authenticate its associated resource, and
means for recording authentication information for each designated workflow step.

22. A system as claimed in claim 21 comprising means for identifying the resource using a resource identifier associated with the resource.

23. A system as claimed in claim 22 wherein the resource identifier is unique to the resource with which it is associated.

24. A system as claimed in claim 21 wherein the resource identifier comprises at least one of a bar code; an RFID tag; a light sensitive tag; a fluorescent tag; or a unique number.

25. A system as claimed in claim 21 wherein the resource includes at least one of a user, a location, an item or an apparatus.

26. A system as claimed in claim 21 wherein the security feature includes an encryption key for use in authenticating the security feature.

27. A system as claimed in claim 21 wherein the resource identifier includes an encryption key for use in authenticating the security feature.

28. A system as claimed in claim 21 comprising a workflow authentication store for storing all recorded authentication information for the workflow.

29. A system as claimed in claim 21 wherein the means for reading the security feature comprise a reader instrument.

30. A system as claimed in claim 29 wherein the means for authenticating the security feature are in the reader instrument.

31. A system as claimed in claim 29 wherein the results of the authentication are stored remotely from the reader instrument.

32. A system as claimed in claim 29 wherein the reader instrument is operable to receive a workflow from a remote location.

33. A system as claimed in claim 21 comprising means for registering a new resource for use within the workflow system.

34. A system as claimed in claim 33 comprising means for applying one or more security features to a tag or marker associated with the resource being registered.

35. A system as claimed in claim 21 wherein the one or more security features are overt and/or covert.

36. A system as claimed as claimed in claim 21 wherein the or each security feature is machine-readable.

37. A system as claimed as claimed in claim 21 comprising means for issuing a secure certificate to indicate that one or more designated workflow steps are completed.

38. A system as claimed in claim 37 wherein the certificate is a digital certificate.

39. A system as claimed in claim 37 wherein the certificate is issued as an electronic and/or physical certificate.

40. A workflow authentication system configured to:
provide one or more workflows to a plurality of workflow stations, each workflow having one or more designated steps requiring authentication;
receive authentication information that has been captured from a security feature associated with a resource specified in at least one of the workflows, and
record authentication information for each designated workflow step.

41. A system as claimed in claim 40 wherein a plurality of workflow stations is provided and at least two of the workflows provided are sub-sets of another larger workflow.

42. A system as claimed in claim 40 wherein different workflows are provided to different workflow stations.

43. A system as claimed in claim 40 wherein the authentication information provided by a workflow station indicates that the workflow is authenticated.

44. A system as claimed in claim 40 wherein the authentication information provided by a workflow station is used together with other information to identify whether the workflow is authenticated.

45. A system as claimed in claim 40 wherein the or each workflow is downloaded to the reader instruments from a remote location.

46. A system as claimed in claim 40 wherein the or each workflow is digitally signed or encrypted.
